(19) United States
(12) Patent Application Publication
(10) Pub. No.: US 2003/0036392 A1
(43) Pub. Date: Feb. 20, 2003

(54) Wireless network gateway

(76) Inventor: Satoru Yukie, San Diego, CA (US)

Correspondence Address: FROMMER LAWRENCE & HAUG, 745 FIFTH AVENUE- 10TH FL., NEW YORK, NY, 10151, US

(21) Appl. No.: 09/932,312

(22) Filed: Aug. 17, 2001

(51) Int. Cl. H04Q 7/20

(52) U.S. Cl. 455/461; 455/456

(57) ABSTRACT

Methods and apparatus for implementing a network gateway that links two or more wireless networks, such as a packet switched network and a circuit switched network. In one implementation, a network gateway includes: an identification database including one or more mobile unit entries, where each mobile unit entry indicates a subscriber information database storing subscriber information for the mobile unit corresponding to the mobile unit entry; a subscriber information database including one or more subscriber entries, where each subscriber entry indicates for a corresponding mobile unit a location, a status, and any services subscribed to by the corresponding mobile unit; an identifier table including an identifier entry for each subscriber entry in the subscriber information database, where each identifier entry indicates a correspondence between a first identifier and a second identifier; a primary network connection connected to a first wireless network, where the first wireless network is a packet switched network; and a secondary network connection connected to second wireless network.

### RELATED APPLICATIONS

This application is related to the following co-pending and commonly assigned patent application: “DUAL NETWORK MODEM,” application Ser. No. ______ (filed on Aug. 10, 2001), the disclosure of which is incorporated herein by reference.

### BACKGROUND

The present invention relates to wireless modems and wireless data networks.

Data as well as voice can be transmitted over existing wireless data networks. Typically, these networks are either circuit switched networks or more recent packet switched networks. In a circuit switched network a temporary dedicated connection is created for communication between two nodes. This connection is maintained throughout the session. Circuit switched networks are typically designed for voice communication. Examples of wireless circuit switched networks include networks using CDMA, such as IS-95 (cdmaOne), IS-95B, or cdma2000, and GSM networks using TDMA. A cellular telephone (“cell phone”) in a typical circuit switched network has a unique telephone number.

In a packet switched network, information is broken into small packets (“packetized”) and packets are individually sent to their destination. The path that individual packets take through the network may vary between packets. The packets are reassembled at the destination. Wireless packet switched networks are typically designed for data transmission. Wireless packet switched networks also typically have faster data transmission rates than wireless circuit switched networks. Examples of wireless packet switched networks include networks using iBurst™ (by ArrayComm, Inc.), flash-OFDM™ (by Flarion Technologies, Inc.), and Ricochet™ (by Metricom, Inc.). A terminal in a typical packet switched network has a unique address, such as a dynamically assigned IP address.

Some conventional cell phones are dual-mode and capable of roaming. A typical dual-mode cell phone can send and receive voice through either of two compatible circuit switched networks. The cell phone selects which of the two networks to use, depending on factors such as availability and quality of connection. Accordingly, a user can “roam” through coverage areas for each of the two networks and still obtain or maintain a connection.

### SUMMARY

The present invention provides methods and apparatus for implementing a network gateway that links two or more wireless networks, such as a packet switched network and a circuit switched network. In one implementation, a network gateway includes: an identification database including one or more mobile unit entries, where each mobile unit entry indicates a subscriber information database storing subscriber information for the mobile unit corresponding to the mobile unit entry; a subscriber information database including one or more subscriber entries, where each subscriber entry indicates for a corresponding mobile unit a location, a status, and any services subscribed to by the corresponding mobile unit; an identifier table including an identifier entry for each subscriber entry in the subscriber information database, where each identifier entry indicates a correspondence between a first identifier and a second identifier; a primary network connection connected to a first wireless network, where the first wireless network is a packet switched network; and a secondary network connection connected to second wireless network.

In another implementation, a method of providing subscriber information for a mobile unit subscribed to a primary network roaming in a secondary network includes: receiving a request at a gateway in a primary network for subscriber information for a mobile unit from a secondary network, where the request includes a first identifier indicating the mobile unit; converting the first identifier to a second identifier; retrieving subscriber information using the second identifier; and providing a response from the gateway to the secondary network, where the response includes the retrieved subscriber information and the first identifier.

In another implementation, a method of sending data from a mobile unit through a wireless circuit switched network includes: receiving data from a mobile unit at a base station in a wireless circuit switched network, where the data indicates a destination for the data, a requested data transmission service, and an identifier corresponding to the mobile unit, and where the mobile unit is a subscriber in a wireless packet switched network; sending the data from the base station to a mobile switching center; retrieving subscriber information corresponding to the identifier from a subscriber information database in the wireless packet switched network, where the subscriber information indicates permitted services for the mobile unit; comparing the destination and requested data transmission service with the subscriber information; if the destination is accessible through an external packet switched network connected to the wireless packet switched network, sending the data to the external packet switched network through a router; and if the destination is accessible through an external circuit switched network connected to the wireless packet switched network, sending the data to the external circuit switched network through an exchange switch.

In another implementation, a method of sending data to a mobile unit through a wireless packet switched network and a wireless circuit switched network includes: receiving data from an external network in a wireless packet switched network, where the data includes an identifier corresponding to a mobile unit; retrieving status information corresponding to the identifier from a subscriber information database, where the status information indicates the mobile unit is registered in a wireless circuit switched network; requesting a temporary local directory number from the wireless circuit switched network; sending the data and the temporary local directory number to an exchange switch; and sending the data from the exchange switch to the wireless circuit switched network using the temporary local directory number.

### BRIEF DESCRIPTION OF THE DRAWINGS

FIG. 1 shows coverage areas for two overlapping networks.

FIG. 2 shows a network system according to the present invention.

FIG. 3 is a block diagram of a wireless packet switched network according to the present invention.

FIG. 4 is a block diagram of a wireless circuit switched network according to the present invention.

FIG. 5 is a flowchart of registering a mobile unit in the secondary network according to the present invention.

FIG. 6 is a flow chart of registering a mobile unit in the primary network according to the present invention.

FIG. 7 is a flow chart of registering a visiting mobile unit in the primary network according to the present invention.

FIG. 8 is a flow chart of sending outgoing data from a mobile unit through the primary network according to the present invention.

FIG. 9 is a flow chart of sending outgoing data from a mobile unit through the secondary network, where the mobile unit is a subscriber of the primary network according to the present invention.

FIG. 10 is a flow chart of sending incoming packet data to a mobile unit according to the present invention.

FIG. 11 is a flow chart of sending incoming data from the PSTN to a mobile unit according to the present invention.

### DETAILED DESCRIPTION

The present invention provides methods and apparatus for implementing a gateway that links two or more wireless networks, such as a packet switched network and a circuit switched network. The gateway facilitates transfer of subscriber information between two networks. The gateway also converts identifiers among the types of identifiers used in the connected networks. Accordingly, the gateway facilitates the use of a mobile unit that can communicate with both a packet switched network and a circuit switched network, such as the wireless modem described in the U.S. Patent Application for “DUAL NETWORK MODEM,” application Ser. No. ______ (filed Aug. 10, 2001).

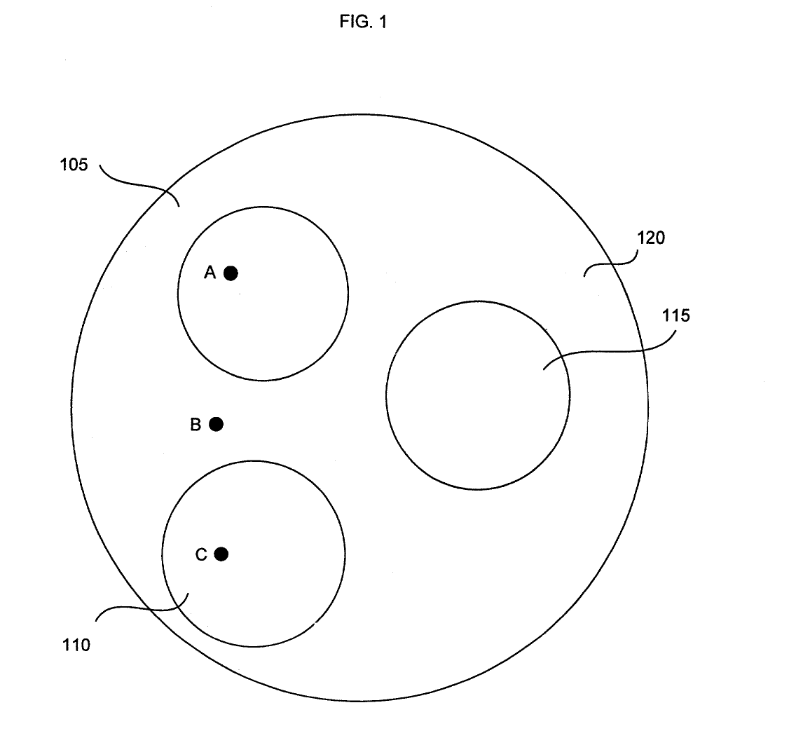

FIG. 1 shows coverage areas for two overlapping networks. Each network is a wireless data network. For example, the first network can be a packet switched network carrying data as IP packets, and the second network can be a circuit switched network such as a cdmaOne network. The first network has coverage areas 105, 110, 115. The second network has coverage area 120. Coverage areas 105, 110, 115 overlap coverage area 120. FIG. 1 also shows three physical locations indicated by points A, B, C. Points A and C are within coverage areas 105 and 110, respectively, for the first network and coverage area 120 of the second network. Point B is within coverage area 120 of the second network but not within a coverage area of the first network. Accordingly, a user of a mobile unit at point A or C can transmit and receive data using either the first network or the second network. A user at point B can transmit and receive data using the second network but not the first network. Similarly, a user moving from point A to point C can transmit and receive data using either a combination of the first network and the second network or using only the second network.

When the first network has a higher data transmission rate than the second network, it may be desirable to use the first network rather than the second network when possible. However, it may also be desirable to continue to transmit and receive data from various locations which are outside the coverage areas for the first network. Accordingly, it is advantageous to provide an interface among wireless data networks facilitating a user roaming (i.e., physically moving through different coverage areas) across multiple wireless data networks. The present invention provides a gateway between two or more networks to facilitate a mobile unit transmitting and receiving data across the networks, such as with a packet switched network and a circuit switched network.

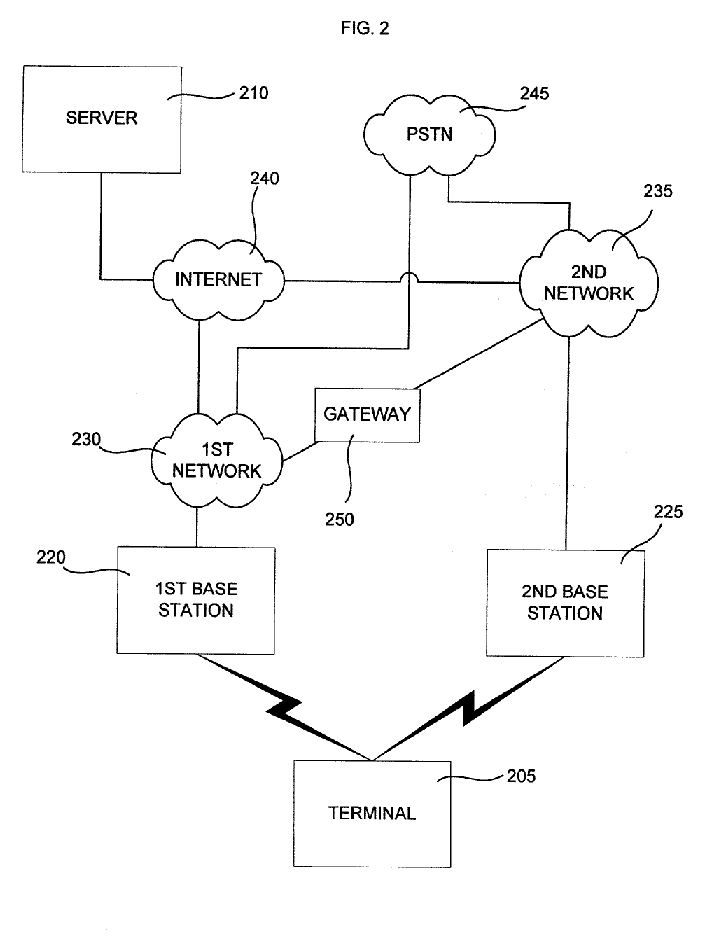

FIG. 2 shows a network system. A terminal or mobile unit 205 includes a wireless modem that operates in either of two wireless networks. Terminal 205 can be implemented as various mobile or portable devices, such as a telephone, a PDA (personal digital assistant), or a notebook computer. In an alternative implementation, terminal 205 is fixed but the wireless modem is portable. Terminal 205 communicates with a server 210 through the wireless networks.

Terminal 205 can transmit and receive data to and from first base station 220 and also to and from second base station 225. Terminal can transmit various types of data, including voice. First base station 220 is part of a first wireless network 230. Second base station 225 is part of a second wireless network 235. Base stations 220, 225 are the entry points for wireless communication with networks 230, 235, respectively. In one implementation, first network 230 is a packet switched network and second network 235 is a circuit switched network. First network 230 and second network 235 are connected to server 210 through the Internet 240. First network 230 and second network 235 are also connected to the PSTN 245 (public switched telephone network; including associated networks, such as an SS7 signaling network).

First network 230 and second network 235 are interconnected by a network gateway 250. First network 230 and second network 235 can communicate with one another through gateway 250, as well as through the Internet 240 or the PSTN 245. In one implementation, gateway 250 is part of first network 230. Gateway 250 provides information between first network 230 and second network 235 to facilitate terminal 205 operating in either first network 230 or second network 235. In one implementation, gateway 250 is connected to second network 235 through a public signaling network, such as an SS7 connection. In addition, gateway 250 provides conversion between different types of identifiers used in networks 230, 235. For example, where first network 230 is a packet switched network using IP addresses and second network 235 is a circuit switched network using telephone numbers, gateway 250 provides a conversion between the two types of identifiers so that each network can refer to terminal 205 using that network's identifier.

Terminal 205 can send data to server 210 by establishing a connection to first base station 220. First base station 220 provides data from terminal 205 to server 210 through first network 230 and the Internet 240. Similarly, server 210 can transmit data to terminal 205 through the Internet 240, first network 230, and the connection between first base station 220 and terminal 205. When first network 230 is a packet switched network, data to and from terminal 205 is sent through first network 230 as packets, possibly using various paths through first network 230.

Terminal 205 can also send data to server 210 by establishing a connection to second base station 225. Second base station 225 provides data from terminal 205 through second network 235 and the Internet 240. Similarly, server 210 can transmit data to terminal 205 through the Internet 240, second network 235, and the connection between second base station 225 and terminal 205. When second network 235 is a circuit switched network, data to and from terminal 205 is sent through second network 235 using a temporary dedicated connection.

In a similar way, terminal 205 can send and receive data to and from PSTN 245 through either first network 230 or second network 235. Accordingly, terminal 205 can communicate with the Internet 240 and the PSTN 245, as well as connected devices (e.g., server 210), through first network 230 and second network 235.

In one implementation, first network 230 is a primary or default network. Second network 235 is a secondary or alternate network. The secondary network is also a partner network of the primary network (i.e., a network that has a relationship with the primary network, such as to allow subscribers of each network to roam in the other). Terminal 205 has a subscription with the primary network and can also use the secondary network, such as for improved access under poor conditions for the primary network or when roaming. Terminal 205 selects which network to use according to selection criteria, such as data rate, cost, energy consumption, or a combination of criteria. In one implementation, terminal 205 attempts to establish a connection to the primary network (first network 230) and if that connection fails, attempts to establish a connection to the secondary network (second network 235).

The primary network stores subscriber information and provides the subscriber information through gateway 250 to secondary or alternate networks upon request. When terminal 205 establishes a connection through second network 235, second network 235 requests subscriber information from first network 230 through gateway 250. In one implementation, second network 235 uses an identifier in the request that is specific to second network 235. Gateway 250 converts the identifier to an identifier specific to first network 230 to retrieve the requested information. In alternative implementations, more than two networks are available, one primary network and multiple secondary networks.

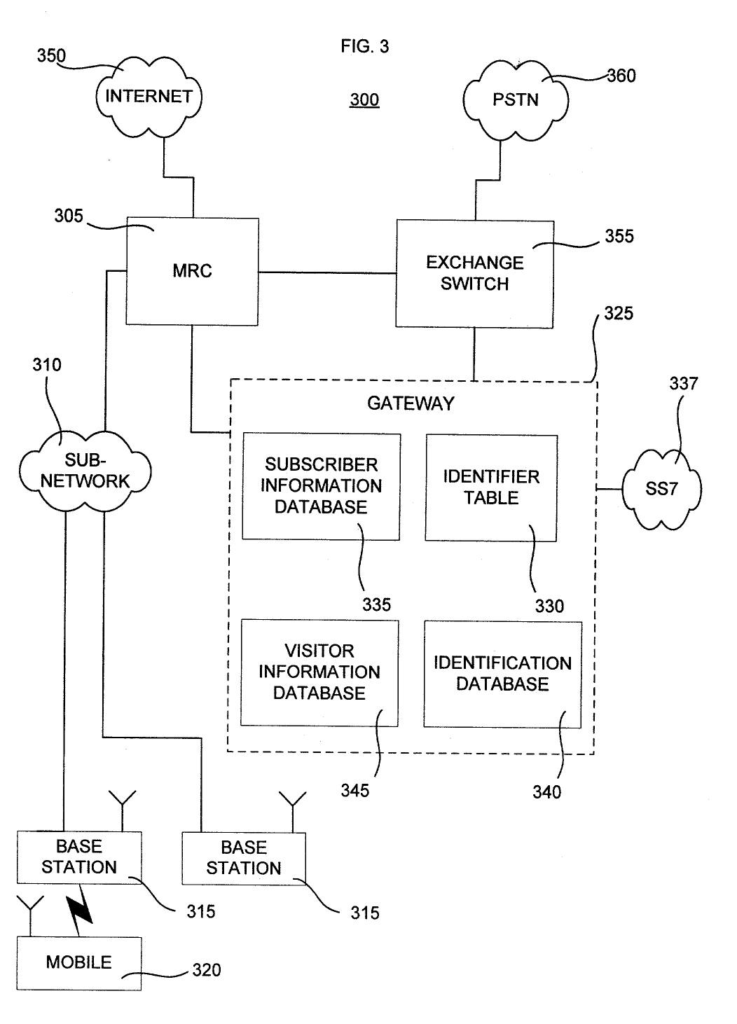

FIG. 3 is a block diagram of a wireless packet switched network 300, such as first network 230 in FIG. 2. A mobile routing center (“MRC”) 305 provides administrative control for wireless network 300, such as managing network operation. MRC 305 is connected to a sub-network 310. Sub-network 310 is connected to one or more base stations 315 (only two base stations 315 are shown in FIG. 3 for clarity). Sub-network 310 is a packet switched network and transmits data as packets among MRC 305 and base stations 315, such as through internal connections and routers or switches. In an alternative implementation, sub-network 310 is a collection of direct connections between base stations 315 and MRC 305. A mobile unit 320, such as terminal 205 in FIG. 2, can create a wireless connection to a base station 315.

MRC 305 is connected to a gateway 325, such as gateway 250 in FIG. 2. As described above, gateway 325 sends and receives subscriber information to and from connected partner networks, as well as identifier conversion. Gateway 325 includes an identifier table 330, a subscriber information database 335, an identification database 340, and a visitor information database 345. In alternative implementations, these components of gateway 325 are separate interconnected pieces in the network and gateway 325 manages communication with partner networks. Gateway 325 is connected to one or more partner wireless networks. In one implementation, gateway 325 is connected to a partner wireless circuit switched network through an SS7 connection 337. Gateway 325 exchanges subscriber information with partner networks across this connection.

Identifier table 330 includes entries that each indicate a correspondence between two or more types of identifiers, such as network addresses and telephone numbers. In one implementation, each entry in identifier table 330 indicates a correspondence between an IP address, a telephone number, and a network identifier (e.g., an identifier internal to wireless network 300, or an identifier not specific to a particular network technology to be converted by compatible networks to internal identifiers). In one implementation, the gateway uses the IP address of the mobile unit for accessing the databases in the primary network and converts the IP address to a telephone number to interact with the secondary network. In an alternative implementation, the MIN or ESN (electronic serial number) of the mobile unit is used to refer to the mobile unit and the IP address and telephone number are used for data flow (e.g., routing and switching). Each entry corresponds to a mobile unit subscribed to wireless network 300 or subscribed to a partner network of wireless network 300. For example, in one implementation, gateway 325 uses identifier table 330 to find an IP address corresponding to a telephone number for a subscriber supplied by partner circuit switched network.

Subscriber information database 335 stores subscriber information, such as customer profiles, for mobile units subscribed to wireless network 300. In one implementation, subscriber information database 335 is a typical home location register (HLR). Subscriber information database 335 includes an entry for each subscribing mobile unit. Each entry indicates information about the mobile unit's status and subscription, such as active/inactive (i.e., whether the mobile unit is on or off), location (e.g., which cell in which network), and available services.

Identification database 340 stores information indicating the location of subscriber information databases or HLR's for mobile units. In one implementation, identification database 340 includes an entry for each mobile unit that can access wireless network 300. Each entry indicates the location of the HLR or subscriber information database corresponding to the mobile unit so gateway 325 can connect to the mobile unit's HLR or subscriber information database to request subscriber information. The index for identification database 340 is a unique identifier for each mobile unit, such as the mobile identification number (MIN). Alternatively, MRC 305 retrieves this identification information from a database external to wireless network 300.

Visitor information database 345 stores subscriber information about visiting mobile units registered in wireless network 300 (e.g., mobile units subscribed to a partner network that are roaming in wireless network 300). In one implementation, visitor information database 345 is a visitor location register (VLR). Each entry in visitor information database 345 includes subscriber information received from the HLR or subscriber information database corresponding to the visiting mobile unit.

MRC 305 also provides a connection to an external packet switched network 350, such as the Internet 240. MRC 305 includes a router for sending and receiving data to and from the Internet 350. Incoming data packets arrive at MRC 305 and MRC 305 routes the packets to the appropriate destination (e.g., a particular mobile unit 320 through sub-network 310 and a base station 315).

An exchange switch 355 provides a connection to an external circuit switched network 360, such as the PSTN 245. Exchange switch 355 is connected to MRC 305 and gateway 325. Exchange switch 355 provides PBX (private branch exchange) functionality to wireless network 300. An incoming switched connection arrives at exchange switch 355 and exchange switch 355 passes the data to the appropriate destination. In one implementation, exchange switch 355 is included in gateway 325.

In an alternative implementation, wireless network 300 includes multiple sections. The sections are linked together by a sub-network. Each section has a respective subscriber information database, identification database, and visitor information database. A common gateway provides a connection out to partner networks and identifier conversion.

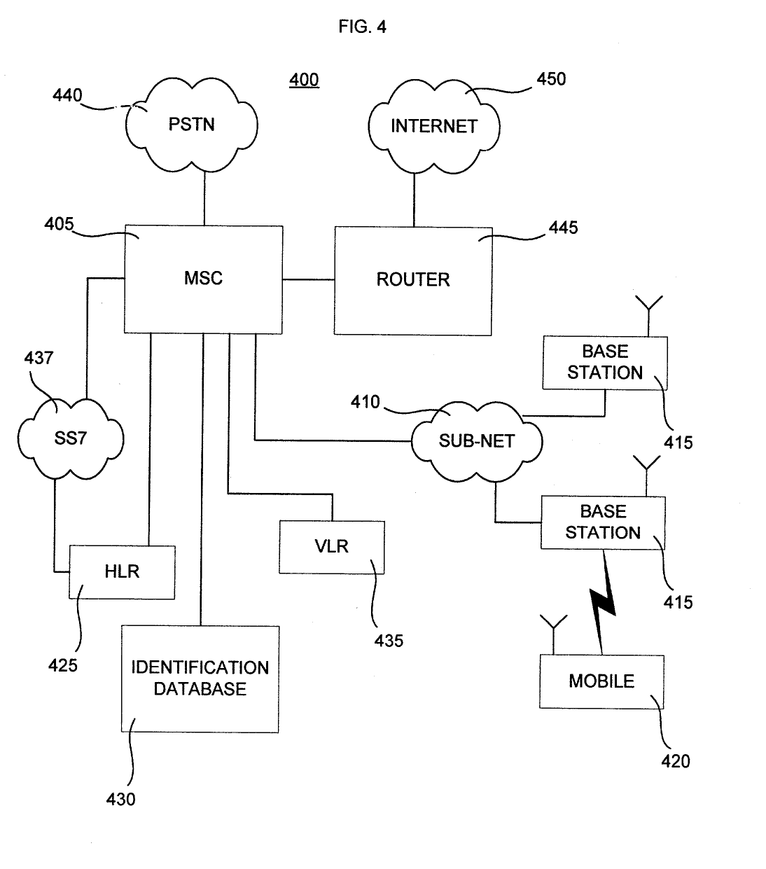

FIG. 4 is a block diagram of a wireless circuit switched network 400, such as second network 235 in FIG. 2. A mobile switching center (“MSC”) 405 provides administrative control for wireless network 400, such as managing subscriber information and data flow. MSC 405 is connected to a sub-network 410. Sub-network 410 is connected to one or more base stations 415 (two base stations 415 are shown in FIG. 4 for clarity). Sub-network 410 is a circuit switched network and transmits data among MSC 405 and base stations 415, such as through temporary dedicated connections. In an alternative implementation, sub-network 410 is a collection of direct connections between base stations 415 and MSC 405. A mobile unit 420, such as terminal 205 in FIG. 2, can create a wireless connection to a base station 415.

MSC 405 is connected to an HLR 425, an identification database 430, and a VLR 435. Wireless network 400 is connected to one or more partner wireless networks through MSC 405 and HLR 425. In one implementation, wireless network 400 is connected to a partner wireless packet switched network, such as wireless network 300 in FIG. 3, through an SS7 connection 437. Wireless network 400 exchanges subscriber information with partner networks across this connection.

HLR 425 stores subscriber information, such as customer profiles, for mobile units subscribed to wireless network 400. HLR 425 includes an entry for each subscribing mobile unit. Each entry indicates information about the mobile unit's status and subscription, such as active/inactive (i.e., whether the mobile unit is on or off), location (e.g., which cell in which network), and available services.

Identification database 430 stores information indicating the location of subscriber information databases or HLR's for mobile units. In one implementation, identification database 430 includes an entry for each mobile unit that can access wireless network 400. Each entry indicates the location of the HLR or subscriber information database corresponding to the mobile unit so HLR 425 or MSC 405 can connect to the mobile unit's HLR or subscriber information database to request subscriber information. The index for identification database 430 is a unique identifier for each mobile unit, such as the mobile identification number (MIN). Alternatively, MSC 405 retrieves this identification information from a database external to wireless network 400.

VLR 435 stores subscriber information about visiting mobile units registered in wireless network 400 (e.g., mobile units subscribed to a partner network, such as wireless network 300 in FIG. 3, that are roaming in wireless network 400). Each entry in VLR 435 includes subscriber information received from the HLR or subscriber information database corresponding to the visiting mobile unit.

MSC 405 also provides a connection to an external circuit switched network 440, such as the PSTN 245. MSC 405 includes a switch for sending and receiving data to and from the PSTN 440. An incoming switched connection arrives at MSC 405 and MSC 405 passes the data to the appropriate destination.

A router 445 provides a connection to an external packet switched network 450, such as the Internet 240. Incoming data packets arrive at router 445 and router 445 provides the data to MSC 405 to be switched to the appropriate destination (e.g., a particular mobile unit 420 through sub-network 410 and a base station 415).

In operation, the interaction between a primary network and a secondary network includes three areas: registration, outgoing data, and incoming data. Registration identifies a mobile unit in a wireless network and records the mobile unit's status and location. Outgoing data passes from a mobile unit through a wireless network. Incoming data passes through a wireless network to a mobile unit. Various types of data can be supported, including voice. The operation of the network gateway in these areas of operation is described below. The description below uses the context of a mobile unit operating in a primary network that is a wireless packet switched network, such as wireless network 300 in FIG. 3, or a secondary partner network that is a wireless circuit switched network, such as wireless network 400 in FIG. 4. The mobile unit is a subscriber in the primary network, unless otherwise noted. Alternative network environments are also possible and the network gateway is compatible with various environments.

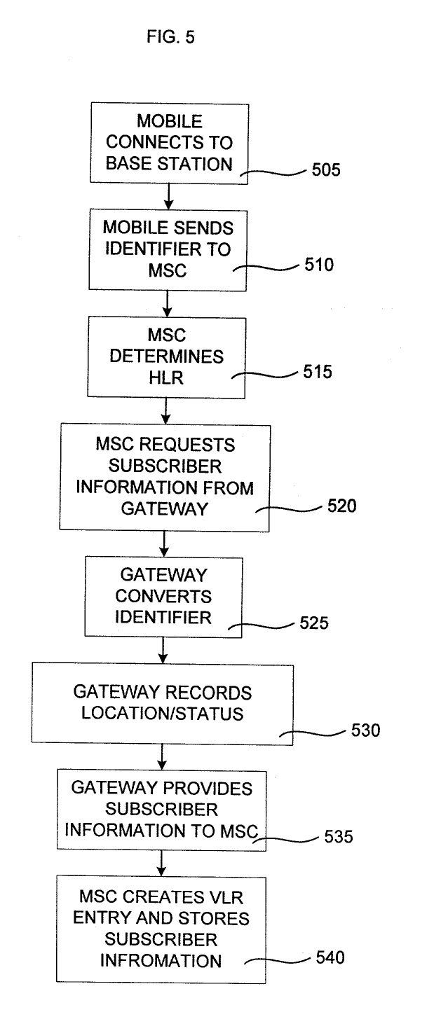

FIG. 5 is a flowchart of registering a mobile unit in the secondary network. The mobile unit establishes a connection with a base station in the secondary network, block 505. The mobile unit establishes this connection on power-up or entering the coverage area for the secondary network. The mobile unit passes a unique identifier to the base station and on to the MSC, block 510. In one implementation, the identifier is an MIN. The MSC determines the location of the HLR or subscriber information database storing subscriber information for the mobile unit, block 515. The MSC locates the HLR or subscriber information database such as by checking an identification database as described above. The identification database in the secondary network indicates the subscriber information for the mobile unit is stored in the gateway of the primary network. The MSC requests the subscriber information for the mobile unit from the gateway of the primary network, block 520. Alternatively, the HLR requests the subscriber information from the gateway. The MSC sends the request for subscriber information across an SS7 connection. The request also includes information indicating the current location and status of the mobile unit. In one implementation, the MSC identifies the mobile unit using a telephone number. The gateway converts the telephone number to an IP address using an identifier table, block 525. The gateway records the location and status information for the mobile unit in the gateway's subscriber information database, block 530. The gateway retrieves the requested subscriber information and provides the subscriber information to the MSC, block 535. The MSC creates an entry in a VLR and stores the received subscriber information in that entry as well as the location and status of the mobile unit, block 540. The mobile unit is now registered in the secondary network and the primary network has recorded the mobile unit's current location and status.

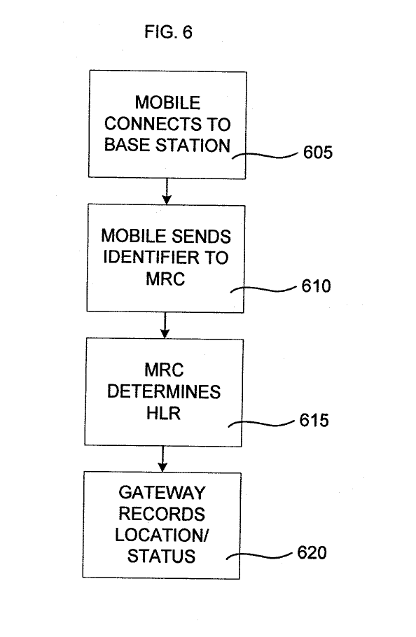

FIG. 6 is a flow chart of registering a mobile unit in the primary network. The mobile unit establishes a connection with a base station in the primary network, block 605. The mobile unit passes a unique identifier to the base station and on to the MRC, block 610. The MRC determines the location of the HLR or subscriber information database storing subscriber information for the mobile unit, block 615. The MRC locates the HLR or subscriber information database by sending a request to the gateway. The gateway checks the identification database and determines that the subscriber information for the mobile unit is stored in the subscriber information database of the primary network. The gateway records the location and status information for the mobile unit in the gateway's subscriber information database, block 620. The mobile unit is now registered in the primary network and the primary network has recorded the mobile unit's current location and status.

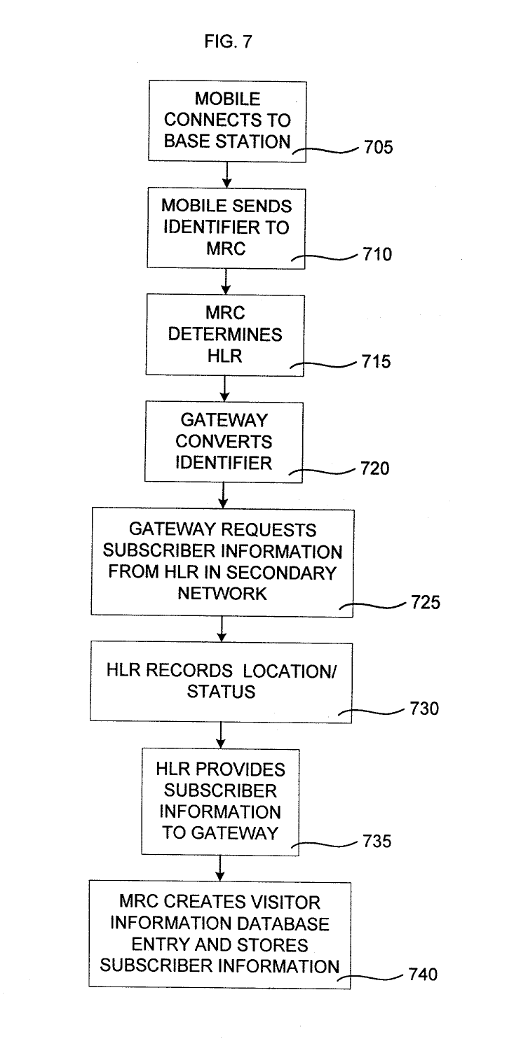

FIG. 7 is a flow chart of registering a visiting mobile unit in the primary network. In this case, the visiting mobile unit is a subscriber of the secondary network and is roaming in a coverage area of the primary network. The visiting mobile unit establishes a connection with a base station in the primary network, block 705. The visiting mobile unit passes a unique identifier to the base station and on to the MRC, block 710. The MRC determines the location of the HLR or subscriber information database storing subscriber information for the visiting mobile unit, block 715. The MRC locates the HLR or subscriber information database by sending a request to the gateway. The gateway checks the identification database and determines that the subscriber information for the visiting mobile unit is stored in the HLR of the secondary network. In one implementation, the MRC identifies the visiting mobile unit to the gateway using an IP address. The gateway converts the IP address to a telephone number using an identifier table, block 720. The gateway requests the subscriber information for the visiting mobile unit from the HLR of the secondary network, block 725. The gateway sends the request across an SS7 connection. The gateway uses the telephone number to identify the visiting mobile unit in the request to the secondary network's HLR. The request also includes information indicating the current location and status of the visiting mobile unit. The secondary network's HLR records the location and status information for the visiting mobile unit, block 730. The secondary network's HLR retrieves the requested subscriber information and provides the subscriber information to the gateway, block 735. The gateway creates an entry in the gateway's visitor information database and stores the received subscriber information in that entry as well as the location and status of the mobile unit, block 740. The visiting mobile unit is now registered in the primary network and the secondary network has recorded the visiting mobile unit's current location and status.

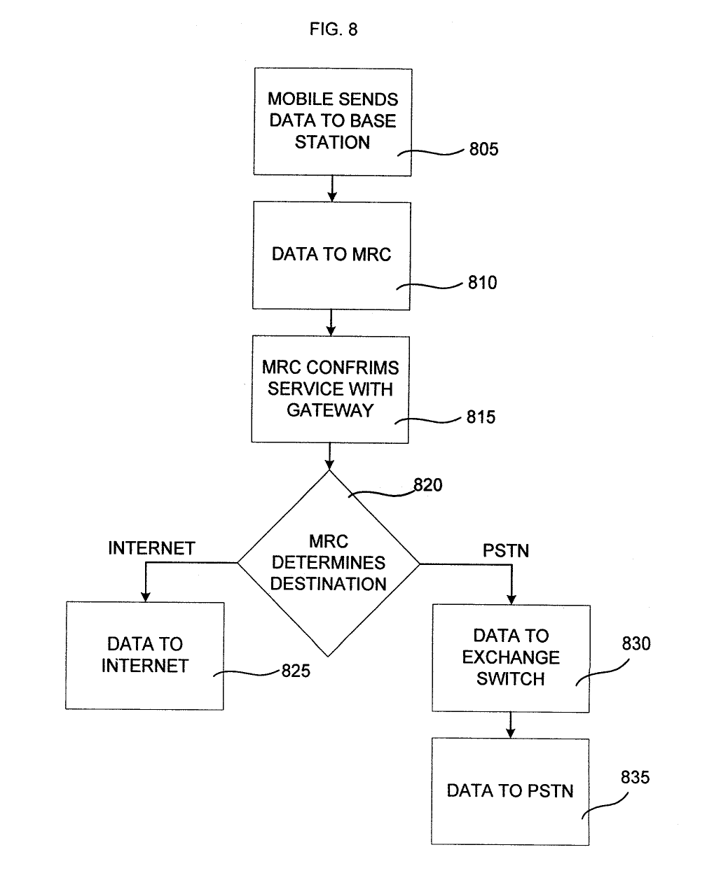

FIG. 8 is a flow chart of sending outgoing data from a mobile unit through the primary network. The mobile unit has already registered with the primary network. The mobile unit sends outgoing data to a base station, block 805. The base station passes the outgoing data to the MRC through the sub-network, block 810. The MRC confirms that the data service requested for the outgoing data is available for the current subscriber by querying the gateway, block 815. The gateway stores information defining a subscriber's available services in the subscriber information database. The MRC determines the destination for the outgoing data, block 820. If the data is being sent to the Internet, the MRC sends the data to the Internet through a router as packets, block 825. If the data is being sent to the PSTN, the MRC sends the data to an exchange switch, block 830. The exchange switch opens a connection to the PSTN and passes the data to the PSTN, block 835. In one implementation, the exchange switch retrieves a telephone number corresponding to the mobile unit from the gateway and sends the telephone number along with the outgoing data to the PSTN.

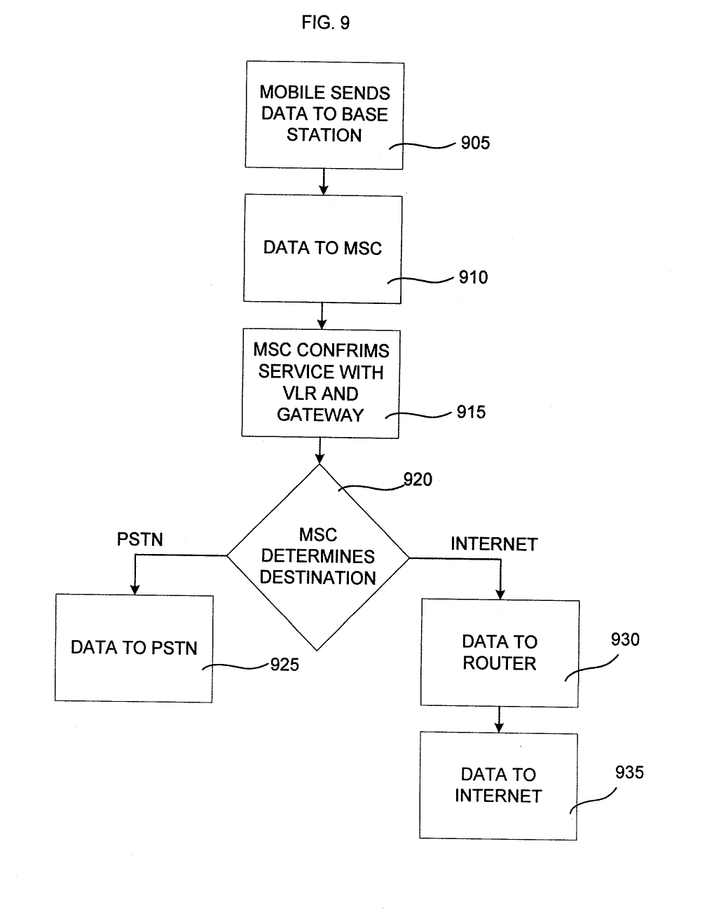

FIG. 9 is a flow chart of sending outgoing data from a mobile unit through the secondary network, where the mobile unit is a subscriber of the primary network. The mobile unit has already registered with the secondary network. The mobile unit sends outgoing data to a base station in the secondary network, block 905. The base station passes the outgoing data to the MSC through the sub-network, block 910. The MSC confirms that the data service requested for the outgoing data is available for the subscriber by querying the VLR, block 915. The VLR stores subscriber information received from the gateway of the primary network during registration of the mobile unit. For some services, the MSC also confirms that the requested data service is available by querying the gateway as well, such as for transmitting a very large data file. In one implementation, the MSC queries the gateway using a telephone number and the gateway converts the telephone number to another identifier to retrieve the subscriber information. The MSC determines the destination for the outgoing data, block 920. If the data is being sent to the PSTN, the MSC opens a connection to the PSTN through a switch and passes the data to the PSTN, block 925. If the data is being sent to the Internet, the MSC sends the data to a router, block 930. The router passes the data as packets to the Internet, block 935. In one implementation, the MSC retrieves an IP address corresponding to the mobile unit from the gateway in the primary network and sends the IP address along with the data to the router and the Internet.

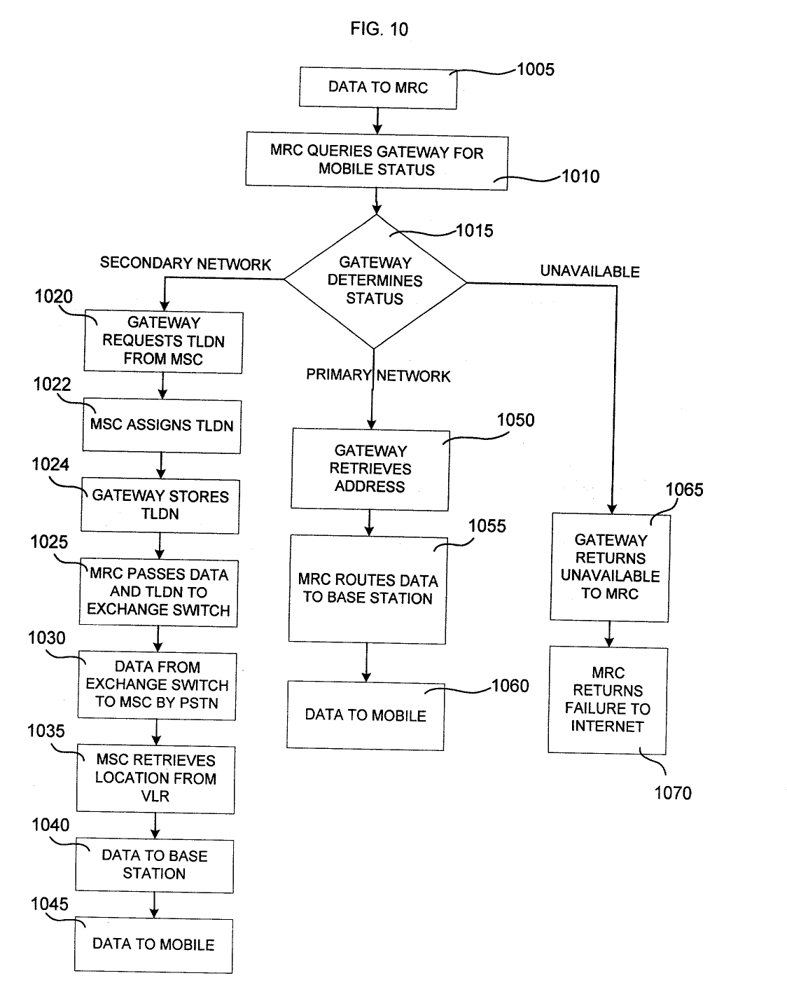

FIG. 10 is a flow chart of sending incoming packet data to a mobile unit. The mobile unit has already registered with one of the wireless networks. Packet data for the mobile unit arrives at the primary network from a packet switched network, such as the Internet. The incoming packet data arrives at the MRC, block 1005. The MRC queries the gateway for the status of the mobile unit, block 1010. The gateway determines the location and status of the mobile unit by checking the subscriber information database, block 1015. As described above, the current location and status of the mobile unit is stored in the subscriber information database during registration. In one implementation, the gateway also confirms that the requested service (i.e., the delivery of the incoming data to the mobile unit) is available to the mobile unit (e.g., that the mobile unit is allowed to receive data of a certain size).

If the gateway determines that the mobile unit is in the secondary network, the gateway requests a temporary local directory number (TLDN) from the MSC in the secondary network, block 1020. In one implementation, the gateway uses the IP address of the mobile unit for accessing the databases in the primary network and converts the IP address to a telephone number to interact with the secondary network. The MSC assigns a TLDN to the mobile unit and stores the TLDN in the VLR of the secondary network, block 1022. The gateway receives the TLDN from the MSC and stores the TLDN in the subscriber information database, block 1024. The MRC receives the TLDN from the gateway and passes the data and the TLDN to the exchange switch, block 1025. The incoming data is sent from the exchange switch to the MSC in the secondary network through the PSTN using the TLDN, block 1030. The MSC retrieves the location of the mobile unit from the VLR, and determines which base station of the secondary network is connected to the mobile unit, block 1035. The MSC sends the incoming data to the base station, block 1040. The base station passes the incoming data to the mobile unit, block 1045.

If the gateway determines that the mobile unit is in the primary network, the gateway retrieves the IP address assigned to the mobile unit from the subscriber information database, and provides the IP address to the MRC, block 1050. The MRC routes the incoming data as packets through the sub-network to the base station connected to the mobile unit, block 1055. The base station passes the incoming data to the mobile unit, block 1060.

If the gateway determines that the mobile unit is inactive or unavailable, the gateway informs the MRC that the mobile unit is unavailable, block 1065. The MRC returns a delivery failure notification to the sender of the incoming data through the Internet, block 1070.

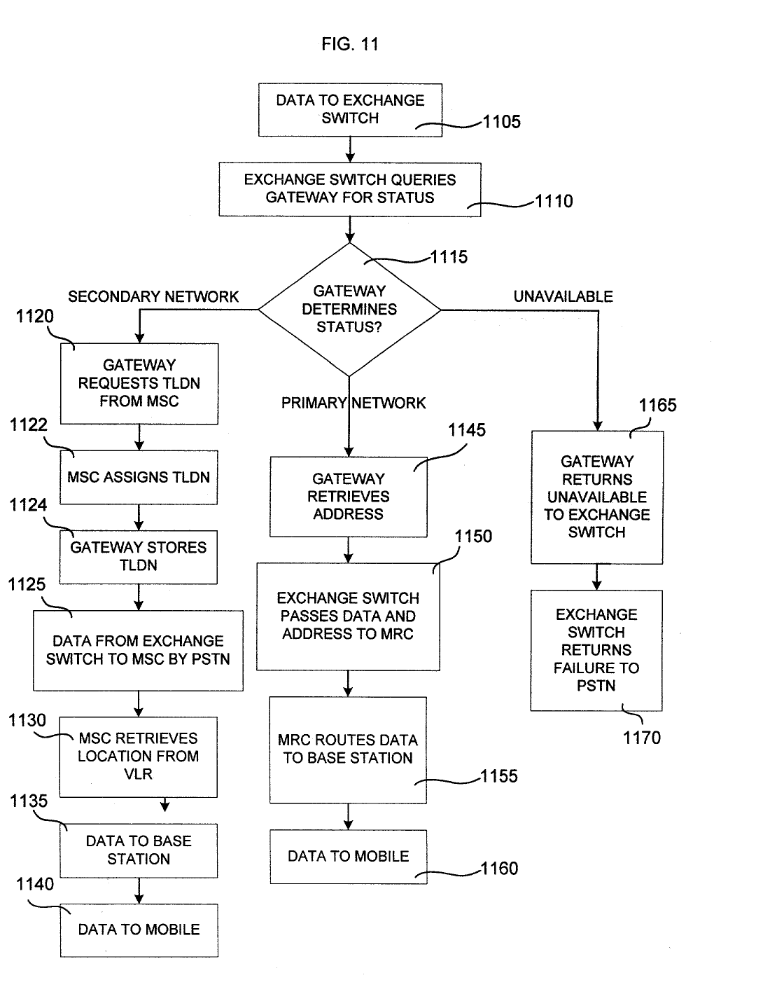

FIG. 11 is a flow chart of sending incoming data from the PSTN to a mobile unit. The mobile unit has already registered with one of the wireless networks. The incoming data from the PSTN arrives at the exchange switch of the primary network, block 1105. The exchange switch queries the gateway for the status of the mobile unit, block 1110. The gateway determines the location and status of the mobile unit by checking the subscriber information database, block 1115. In one implementation, the gateway also confirms that the requested service (i.e., the delivery of the incoming data to the mobile unit) is available to the mobile unit (e.g., that the mobile unit is allowed to receive data of a certain size).

If the gateway determines that the mobile unit is in the secondary network, the gateway requests a TLDN from the MSC in the secondary network, block 1120. In one implementation, the gateway uses the IP address of the mobile unit for accessing the databases in the primary network and converts the IP address to a telephone number to interact with the secondary network. The MSC assigns a TLDN to the mobile unit and stores the TLDN in the VLR of the secondary network, block 1122. The gateway receives the TLDN from the MSC and stores the TLDN in the subscriber information database, block 1124. The exchange switch receives the TLDN from the gateway and sends the data to the MSC through the PSTN using the TLDN, block 1125. The MSC retrieves the location of the mobile unit from the VLR, and determines which base station of the secondary network is connected to the mobile unit, block 1130. The MSC sends the incoming data to the base station, block 1135. The base station passes the incoming data to the mobile unit, block 1140.

If the gateway determines that the mobile unit is in the primary network, the gateway retrieves the IP address assigned to the mobile unit from the subscriber information database, and provides the IP address to the exchange switch, block 1145. The exchange switch passes the data and the IP address to the MRC, block 1150. The MRC routes the incoming data as packets through the sub-network of the primary network to the base station connected to the mobile unit, block 1155. The base station passes the incoming data to the mobile unit, block 1160.

If the gateway determines that the mobile unit is inactive or unavailable, the gateway informs the exchange switch that the mobile unit is unavailable, block 1165. The exchange switch returns a delivery failure notification to the sender of the incoming data through the PSTN, block 1170.

FIGS. 5 through 11 illustrate registering a mobile unit and passing data to and from the mobile unit using two wireless networks. However, in alternative implementations, more than two compatible networks can be connected together through the network gateway. In addition, the description above focuses on the operation of the gateway and a mobile unit subscribed to the wireless packet switched network. The operation of the gateway and a visiting mobile unit (i.e., a mobile unit subscribed to the wireless circuit switched network that can roam in the wireless packet switched network) is similar.

Various illustrative implementations of the present invention have been described. The above description focuses on a network gateway connecting a wireless packet switched network and a wireless circuit switched network, however additional variations are possible. For example, a network gateway may be connected to three wireless networks. As described above, one or more of the wireless networks can be a packet switched network. In addition, the network architectures described are illustrative and additional components can be used in other implementations. The present invention can be implemented in electronic circuitry, firmware, or in combinations of them. For example, the network gateway can be implemented in various ways, such as with an FPGA, a hardwired design, a microprocessor architecture, or a combination. However, one of ordinary skill in the art will see that additional implementations are also possible and within the scope of the present invention. Accordingly, the present invention is not limited to only those implementations described above.

What is claimed is:

1. A network gateway, comprising:
an identification database including one or more mobile unit entries, where each mobile unit entry indicates a subscriber information database storing subscriber information for the mobile unit corresponding to the mobile unit entry;
a subscriber information database including one or more subscriber entries, where each subscriber entry indicates for a corresponding mobile unit a location, a status, and any services subscribed to by the corresponding mobile unit;
an identifier table including an identifier entry for each subscriber entry in the subscriber information database, where each identifier entry indicates a correspondence between a first identifier and a second identifier;
a primary network connection connected to a first wireless network, where the first wireless network is a packet switched network; and
a secondary network connection connected to second wireless network.

2. The network gateway of claim 1, where the second wireless network is a wireless circuit switched network and the secondary network connection is an SS7 connection.

3. The network gateway of claim 1, further comprising a visitor information database including one or more visitor entries, where each visitor entry indicates for a corresponding visiting mobile unit a location, a status, and any services subscribed to by the corresponding visiting mobile unit.

4. The network gateway of claim 1, where the location in a subscriber entry indicates the wireless network where the corresponding mobile unit is currently registered.

5. The network gateway of claim 1, where the first identifier is a telephone number.

6. The network gateway of claim 1, the second identifier is an IP address.

7. The network gateway of claim 1, where each identifier entry further indicates a correspondence among the first identifier, the second identifier, and a third identifier.

8. The network gateway of claim 7, where the third identifier is a mobile identification number.

9. The network gateway of claim 1, further comprising an exchange switch connected to a public switched telephone network.

10. A method of providing subscriber information for a mobile unit subscribed to a primary network roaming in a secondary network, comprising:
receiving a request at a gateway in a primary network for subscriber information for a mobile unit from a secondary network, where the request includes a first identifier indicating the mobile unit;
converting the first identifier to a second identifier;
retrieving subscriber information using the second identifier; and
providing a response from the gateway to the secondary network, where the response includes the retrieved subscriber information and the first identifier.

11. The method of claim 10, where the first identifier is a telephone number.

12. The method of claim 10, where the second identifier is an IP address.

13. The method of claim 10, where the request is to register the mobile unit in the secondary network.

14. The method of claim 10, where the primary network is a wireless packet switched network.

15. A method of sending data from a mobile unit through a wireless circuit switched network, comprising:
receiving data from a mobile unit at a base station in a wireless circuit switched network, where the data indicates a destination for the data, a requested data transmission service, and an identifier corresponding to the mobile unit, and where the mobile unit is a subscriber in a wireless packet switched network;
sending the data from the base station to a mobile switching center;
retrieving subscriber information corresponding to the identifier from a subscriber information database in the wireless packet switched network, where the subscriber information indicates permitted services for the mobile unit;
comparing the destination and requested data transmission service with the subscriber information;
if the destination is accessible through an external packet switched network connected to the wireless packet switched network, sending the data to the external packet switched network through a router; and
if the destination is accessible through an external circuit switched network connected to the wireless packet switched network, sending the data to the external circuit switched network through an exchange switch.

16. The method of claim 15, where the subscriber information database is in a network gateway.

17. The method of claim 15, where the external packet switched network is the Internet.

18. The method of claim 15, where the external circuit switched network is a public switched telephone network.

19. The method of claim 15, where retrieving subscriber information from the subscriber information database comprises:
sending a request from the mobile switching center to the wireless packet switched network including the identifier;
receiving the subscriber information from the wireless packet switched network; and
storing the subscriber information in a visitor information database in the wireless circuit switched network.

20. The method of claim 19, further comprising converting the identifier from the mobile switching center to an IP address and using the IP address to retrieve the subscriber information from the subscriber information database.

21. A method of sending data to a mobile unit through a wireless packet switched network and a wireless circuit switched network, comprising:
receiving data from an external network in a wireless packet switched network, where the data includes an identifier corresponding to a mobile unit;
retrieving status information corresponding to the identifier from a subscriber information database, where the status information indicates the mobile unit is registered in a wireless circuit switched network;
requesting a temporary local directory number from the wireless circuit switched network;
sending the data and the temporary local directory number to an exchange switch; and
sending the data from the exchange switch to the wireless circuit switched network using the temporary local directory number.

22. The method of claim 21, where the subscriber information database is in a network gateway.

23. The method of claim 21, where the external network is an external packet switched network and the data is received at a router.

24. The method of claim 23, where the external packet switched network is the Internet.

25. The method of claim 21, where the external network is an external circuit switched network and the data is received at the exchange switch.

26. The method of claim 25 where the external circuit switched network is a public switched telephone network.

27. The method of claim 25 where the exchange switch retrieves the status information from a network gateway including the subscriber information database.

28. A system for providing subscriber information for a mobile unit subscribed to a primary network roaming in a secondary network, comprising:
means for receiving a request at a gateway in a primary network for subscriber information for a mobile unit from a secondary network, where the request includes a first identifier indicating the mobile unit;
means for converting the first identifier to a second identifier;
means for retrieving subscriber information using the second identifier; and
means for providing a response from the gateway to the secondary network, where the response includes the retrieved subscriber information and the first identifier.
